(19) United States
(12) Patent Application Publication
(10) Pub. No.: US 2002/0122441 A1
(43) Pub. Date: Sep. 5, 2002

(54) Synchronous digital multiplex transmission method and transmission apparatus

(76) Inventors: Tatsuya Kawasumi, Kawasaki (JP); Kazuhiro Yoneda, Kawasaki (JP)

Correspondence Address: KATTEN MUCHIN ZAVIS ROSENMAN, 575 MADISON AVENUE, NEW YORK, NY, 10022-2585, US

(21) Appl. No.: 09/921,425

(22) Filed: Aug. 2, 2001

(30) Foreign Application Priority Data
Mar. 2, 2001 (JP) 20001-059282

(51) Int. Cl. H04J 3/04

(52) U.S. Cl. 370/535; 370/463

(57) ABSTRACT

A synchronous digital multiplex transmission apparatus judges whether a received signal is a SONET AU-3 mapping signal or a SDH AU-4 mapping signal, based on values of H1, H2 and H3 bytes which form H bytes, and carries out an AU-3 pointer process in the case of the AU-3 mapping signal and an AU-4 pointer process in the case of the AU-4 mapping signal, with respect to the received signal. A pointer value is inserted in each of the H1, H2 and H3 bytes in the case of the AU-3 mapping signal and a pointer value is inserted in the H1 bytes in the case of the AU-4 mapping signal, with respect to a transmitting signal.

### BACKGROUND OF THE INVENTION

This application claims the benefit of a Japanese Patent Application No.2001-059282 filed Mar. 2, 2001, in the Japanese Patent Office, the disclosure of which is hereby incorporated by reference.

1. Field of the Invention

The present invention generally relates to transmission methods and transmission apparatuses, and more particularly to a synchronous digital multiplex transmission method and a transmission apparatus which employ a synchronous digital hierarchy (SDH) system and mutually connect to a synchronous optical network (SONET) system.

2. Description of the Related Art

Recently, due to the increase of the Internet users, the amount of data flowing through communication networks is increasing rapidly. As a result, there are demands to increase the capacity and scale of the communication networks. Particularly, the amount of data flowing through international lines is increasing considerably due to the popular use of the Internet, as compared to the past when mainly audio signals were transmitted. Because of this increase of the amount of international communication, there are demands to mutually connect a communication equipment (SONET apparatus) which employs the SONET system used in North America, Taiwan and Hong Kong, and a communication equipment (SDH apparatus) which employs the SDH system used in various other countries.

A SONET optical transmission apparatus designed as prescribed by Bellcore carries out multiplexing by administrative unit (AU)-3 mapping. On the other hand, a SDH optical transmission apparatus designed as recommended by International Telecommunication Union-Telecommunication Standardization Sector (ITU-T) carries out multiplexing by AU-4 mapping.

FIG. 1 is a system block diagram for explaining interworking of a SONET apparatus and a conventional SDH apparatus. A transmitter section 1-1 of a SONET apparatus 1 transmits an AU-3 mapping signal to a receiver section 2-1 of a conventional SDH apparatus 2. A transmitter section 2-2 of the conventional SDH apparatus 2 transmits an AU-4 mapping signal to a receiver section 1-2 of the SONET apparatus 1. A transmitter section 2-3 of the conventional SDH apparatus 2 transmits a signal to an optical transmission apparatus (not shown) located on a downstream side. A receiver section 24 of the conventional SDH apparatus 2 receives a signal transmitted from the optical transmission apparatus located on the downstream side.

Conventionally, when interworking (mutually connecting) the SONET apparatus 1 and the conventional SDH apparatus 2 as shown in FIG. 1, the conventional SDH apparatus 2 cannot correctly receive an AU-3 mapping signal transmitted from the SONET apparatus 1, because the conventional SDH apparatus 2 does not support an AU-3 pointer. Hence, a loss of pointer (LOP) is detected at the receiver section 2-1 of the conventional SDH apparatus 2. As a result, the conventional SDH apparatus 2 which receives the AU-3 mapping signal transmits from the transmitter section 2-3 an AIS signal which indicates a signal disconnection with respect to the optical transmission apparatus located on the downstream side, and there was a problem in that a signal disconnection is generated.

### SUMMARY OF THE INVENTION

Accordingly, it is a general object of the present invention to provide a novel and useful synchronous digital multiplex transmission method and transmission apparatus, in which the problem described above is eliminated.

Another and more specific object of the present invention is to provide a synchronous digital multiplex transmission method and a transmission apparatus, which enable mutual connection with a SONET system.

Still another object of the present invention is to provide a synchronous digital multiplex transmission method comprising the steps of (a) detecting H bytes from an administrative unit group (AUG) forming a synchronous transport module (STM) of a received signal, (b) judging whether the received signal is an AU-3 mapping signal of a synchronous optical network (SONET) or an administrative unit (AU)-4 mapping signal of a synchronous digital hierarchy (SDH) system, based on values of H1 bytes, H2 bytes and H3 bytes which form the H bytes, (c) carrying out an administrative unit (AU)-3 pointer process which uses the H1 bytes, the H2 bytes, the H3 bytes and pointer values thereof, with respect to the received signal, when the received signal is judged as the AU-3 mapping signal by the step (b), (d) carrying out an AU-4 pointer process which uses a pointer value of the H1 bytes, with respect to the received signal, when the received signal is judged as the AU-4 mapping signal by the step (b), (e) inserting a pointer value in each of the H1 bytes, the H2 bytes and the H3 bytes, with respect to a transmitting signal, when the received signal is judged as the AU-3 mapping signal by the step (b), and (f) inserting a pointer value in the H1 bytes, with respect to the transmitting signal, when the received signal is judged as the AU-4 mapping signal by the step (b). According to the synchronous digital multiplex transmission method of the present invention, it is possible to automatically recognize the transmission apparatus of the SONET system and the conventional transmission apparatus of the SDH system and to mutually connect the transmission apparatuses.

A further object of the present invention is to provide a synchronous digital multiplex transmission apparatus comprising H byte detecting means for detecting H bytes from an administrative unit group (AUG) forming a synchronous transport module (STM) of a received signal, AU-3 mapping judging means for judging whether the received signal is an AU-3 mapping signal of a synchronous optical network (SONET), based on values of H1 bytes, H2 bytes and H3 bytes which form the H bytes, AU-3 pointer processing means for carrying out an administrative unit (AU)-3 pointer process which uses the H1 bytes, the H2 bytes, the H3 bytes and pointer values thereof, with respect to the received signal, when the received signal is judged as the AU-3 mapping signal by the AU-3 mapping judging means, and AU-3 pointer inserting means for carrying out an AU-3 pointer insertion by inserting a pointer value in each of the H1 bytes, the H2 bytes and the H3 bytes, with respect to a transmitting signal, when the received signal is judged as the AU-3 mapping signal by the AU-3 mapping judging means. According to the synchronous digital multiplex transmission apparatus of the present invention, it is possible to mutually connect the synchronous digital multiplex transmission apparatus and the transmission apparatus of the SONET system.

Another object of the present invention is to provide a synchronous digital multiplex transmission apparatus comprising H byte detecting means for detecting H bytes from an administrative unit group (AUG) forming a synchronous transport module (STM) of a received signal, provisioning means for instructing an administrative unit (AU)-3 pointer process of a synchronous optical network (SONET) or an administrative unit (AU)-4 pointer process of a synchronous digital hierarchy (SDH) system, AU-3 pointer processing means for carrying out the AU-3 pointer process which uses the H1 bytes, the H2 bytes, the H3 bytes and pointer values thereof, with respect to the received signal, when the AU-3 pointer process is instructed from the provisioning means, AU-4 pointer processing means for carrying out the AU-4 pointer process which uses a pointer value of the H1 bytes, with respect to the received signal, when the AU-4 pointer process is instructed from the provisioning means, AU-3 pointer inserting means for carrying out an AU-3 pointer insertion by inserting a pointer value in each of the H1 bytes, the H2 bytes and the H3 bytes, with respect to a transmitting signal, when the AU-3 pointer process is instructed from the provisioning means, and AU-4 pointer inserting means for carrying out an AU-4 pointer insertion by inserting a pointer value in the H1 bytes, with respect to the transmitting signal, when the AU-4 pointer process is instructed from the provisioning means. According to the synchronous digital multiplex transmission apparatus of the present invention, it is possible to specify the transmission apparatus of the SONET system or the conventional transmission apparatus of the SDH system and to mutually connect the transmission apparatuses.

Still another object of the present invention is to provide a synchronous digital multiplex transmission apparatus comprising H byte detecting means for detecting H bytes from an administrative unit group (AUG) forming a synchronous transport module (STM) of a received signal, mapping judging means for judging whether the received signal is an AU-3 mapping signal of a synchronous optical network (SONET) or an administrative unit (AU)-4 mapping signal of a synchronous digital hierarchy (SDH) system, based on values of H1 bytes, H2 bytes and H3 bytes which form the H bytes, AU-3 pointer processing means for carrying out an administrative unit (AU)-3 pointer process which uses the H1 bytes, the H2 bytes, the H3 bytes and pointer values thereof, with respect to the received signal, when the received signal is judged as the AU-3 mapping signal by the mapping judging means, AU-4 pointer processing means carrying out an AU-4 pointer process which uses a pointer value of the H1 bytes, with respect to the received signal, when the received signal is judged as the AU-4 mapping signal by the mapping judging means, AU-3 pointer inserting means for carrying out an AU-3 pointer insertion by inserting a pointer value in each of the H1 bytes, the H2 bytes and the H3 bytes, with respect to a transmitting signal, when the received signal is judged as the AU-3 mapping signal by the mapping judging means, and AU-4 pointer inserting means for carrying out an AU-4 pointer insertion by inserting a pointer value in the H1 bytes, with respect to the transmitting signal, when the received signal is judged as the AU-4 mapping signal by the mapping judging means. According to the synchronous digital multiplex transmission apparatus of the present invention, it is possible to mutually connect the synchronous digital multiplex transmission apparatus and the transmission apparatus of the SONET system.

A further object of the present invention is to provide a synchronous digital multiplex transmission apparatus comprising a H byte detector which detects H bytes from an administrative unit group (AUG) forming a synchronous transport module (STM) of a received signal, a provisioning section which instructs an administrative unit (AU)-3 pointer process of a synchronous optical network (SONET) or an administrative unit (AU)-4 pointer process of a synchronous digital hierarchy (SDH) system, an AU-3 pointer processor which carries out the AU-3 pointer process using the H1 bytes, the H2 bytes, the H3 bytes and pointer values thereof, with respect to the received signal, when the AU-3 pointer process is instructed from the provisioning section, an AU-4 pointer processor which carries out the AU-4 pointer process using a pointer value of the H1 bytes, with respect to the received signal, when the AU-4 pointer process is instructed from the provisioning section, an AU-3 pointer inserting section which carries out an AU-3 pointer insertion by inserting a pointer value in each of the H1 bytes, the H2 bytes and the H3 bytes, with respect to a transmitting signal, when the AU-3 pointer process is instructed from the provisioning section, and an AU-4 pointer inserting section which carries out an AU-4 pointer insertion by inserting a pointer value in the H1 bytes, with respect to the transmitting signal, when the AU-4 pointer process is instructed from the provisioning section.

Another object of the present invention is to provide a synchronous digital multiplex transmission apparatus comprising a H byte detector which detects H bytes from an administrative unit group (AUG) forming a synchronous transport module (STM) of a received signal, a mapping identifying section which judges whether the received signal is an AU-3 mapping signal of a synchronous optical network (SONET) or an administrative unit (AU)-4 mapping signal of a synchronous digital hierarchy (SDH) system, based on values of H1 bytes, H2 bytes and H3 bytes which form the H bytes, an AU-3 pointer processor which carries out an administrative unit (AU)-3 pointer process using the H1 bytes, the H2 bytes, the H3 bytes and pointer values thereof, with respect to the received signal, when the received signal is judged as the AU-3 mapping signal by the mapping identifying section, an AU-4 pointer processor which carries out an AU-4 pointer process using a pointer value of the H1 bytes, with respect to the received signal, when the received signal is judged as the AU-4 mapping signal by the mapping identifying section, an AU-3 pointer inserting section which carries out an AU-3 pointer insertion by inserting a pointer value in each of the H1 bytes, the H2 bytes and the H3 bytes, with respect to a transmitting signal, when the received signal is judged as the AU-3 mapping signal by the mapping identifying section, and an AU-4 pointer inserting section which carries out an AU-4 pointer insertion by inserting a pointer value in the H1 bytes, with respect to the transmitting signal, when the received signal is judged as the AU-4 mapping signal by the mapping identifying section. According to the synchronous digital multiplex transmission apparatus of the present invention, it is possible to specify the transmission apparatus of the SONET system or the conventional transmission apparatus of the SDH system and to mutually connect the transmission apparatuses.

Other objects and further features of the present invention will be apparent from the following detailed description when read in conjunction with the accompanying drawings.

### BRIEF DESCRIPTION OF THE DRAWINGS

FIG. 1 is a system block diagram for explaining interworking of a SONET apparatus and a conventional SDH apparatus;

FIG. 2 is a diagram showing a STM-N frame structure;

FIG. 3 is a diagram for explaining multiplexing of an AU-3 mapping signal and an AU-4 mapping signal to the STM-N frame;

FIG. 4 is a diagram showing an AUG structure;

FIG. 5 is a diagram showing a structure of a STM-N signal;

FIG. 6 is a diagram for explaining a case where three AU-3 mapping signals are multiplexed as an AUG;

FIG. 7 is a diagram showing a structure of H bytes;

FIG. 8 is a diagram showing a structure of the H bytes of the AUG;

FIG. 9 is a system block diagram showing an important part of a conventional SDH apparatus which receives the AU-4 mapping signal;

FIG. 10 is a system block diagram showing an important part of a SDH apparatus in a first embodiment of the present invention;

FIG. 11 is a system block diagram showing an important part of a SDH apparatus in a second embodiment of the present invention;

FIG. 12 is a system block diagram showing an important part of a SDH apparatus in a third embodiment of the present invention;

FIG. 13 is a system block diagram showing an important part of a SDH apparatus in a fourth embodiment of the present invention;

FIG. 14 is a flow chart for explaining an embodiment of a process carried out by an AU-4 mapping identifying section;

FIG. 15 is a flow chart for explaining an embodiment of a process carried out by an AU-3 mapping identifying section;

FIG. 16 is a flow chart for explaining an embodiment of a process carried out by an AU-3/AU-4 mapping identifying section;

FIG. 17 is a system block diagram showing an embodiment of an AU-4 pointer processor;

FIG. 18 is a system block diagram showing an embodiment of an AU-3 pointer processor; and

FIG. 19 is a system block diagram showing an embodiment of an AU-3/AU-4 pointer processor.

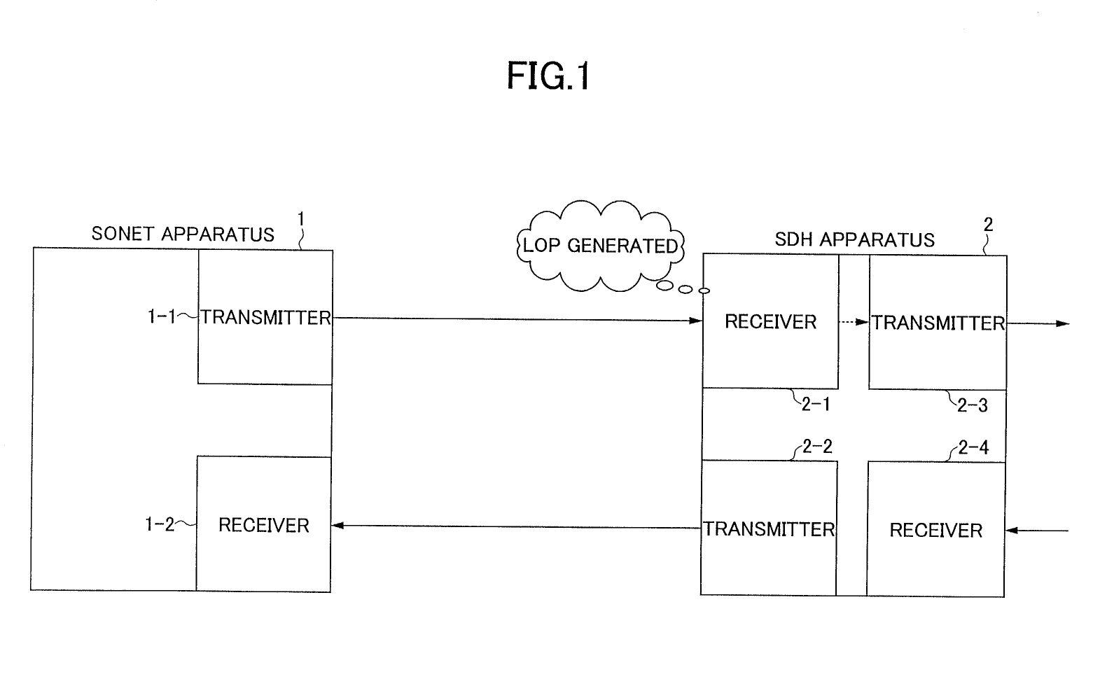

### DESCRIPTION OF THE PREFERRED EMBODIMENTS

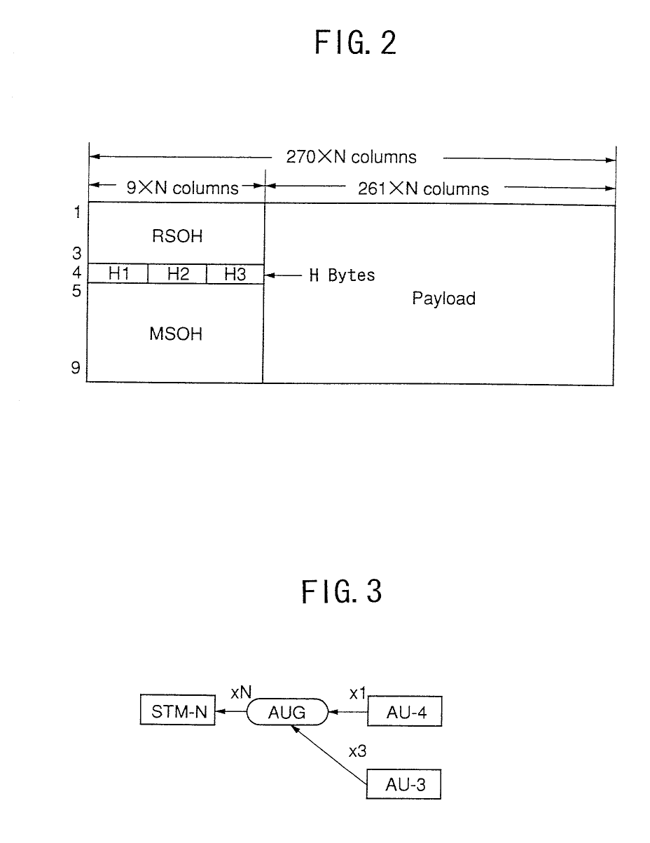

First, a description will be given of the preconditions of the present invention. FIG. 2 is a diagram showing a synchronous transport module (STM-N) frame structure. In both a SONET apparatus and a SDH apparatus, the STM-N frame used includes a section overhead (SOH) made up of a regenerator section overhead (RSOH), a multiplex section overhead (MSOH), as shown in FIG. 2. H bytes (H1, H2, H3) are provided within the SOH. An AU pointer which enables discrimination of the AU-3/AU-4 mapping, is included in the H bytes. In the SONET, the STM-N frame is referred to as an optical carrier (OC-N) frame.

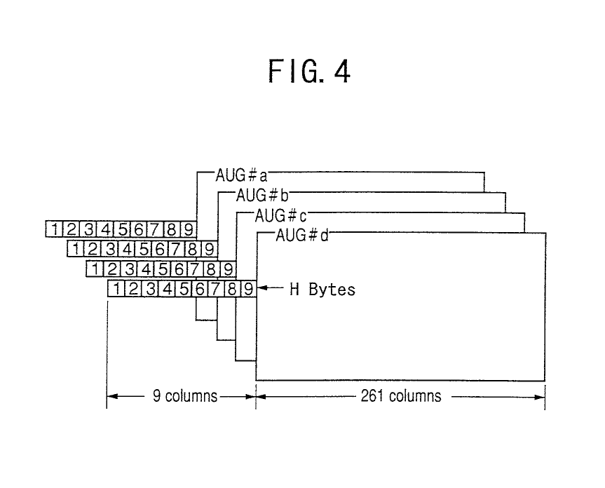

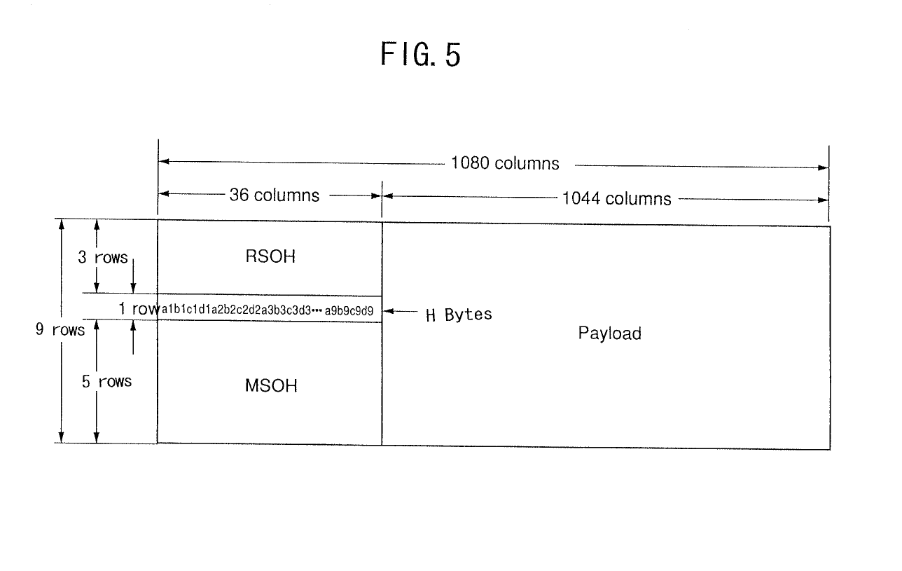

FIG. 3 is a diagram for explaining multiplexing of the AU-3 mapping signal and the AU-4 mapping signal to the STM-N frame. In addition, FIG. 4 is a diagram showing an administrative unit group (AUG) structure, and FIG. 5 is a diagram showing a structure of a STM-N signal. When multiplexing the AU-3 mapping signal and the AU-4 mapping signal to the STM-N frame, the AU-3 mapping signal and the AU-4 mapping signal are multiplexed as an AUG shown in FIG. 4, and the AUG is multiplexed to a STM-N signal shown in FIG. 5.

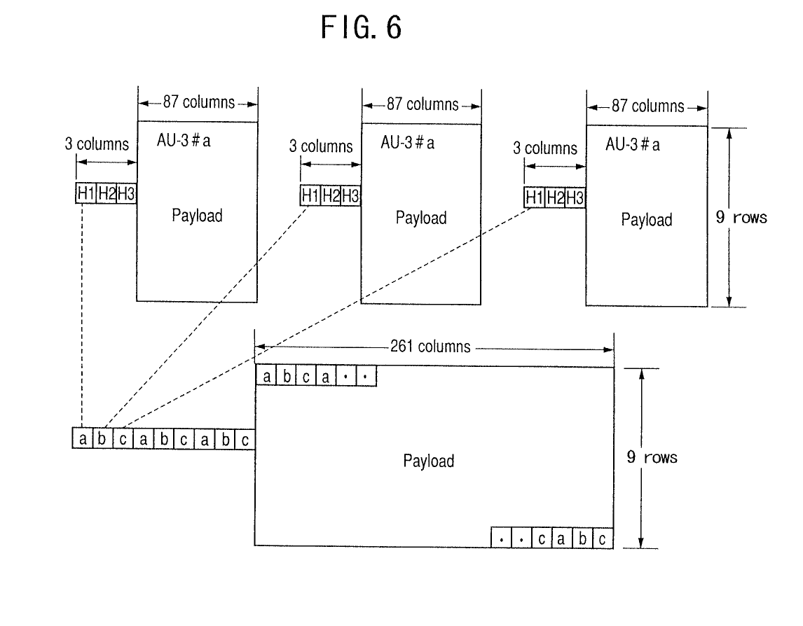

FIG. 6 is a diagram for explaining a case where three AU-3 mapping signals are multiplexed as the AUG. The three AU-3 mapping signals are sequentially multiplexed in units of one byte by a byte interleave multiplexing. In addition, in the case of the AU-4 mapping signal, one AU-4 mapping signal becomes the AUG, and thus, a payload of the AU-4 mapping signal has a capacity which is three times that of a payload of the AU-3 mapping signal. The AU pointer indicates a byte within the STM-N frame forming a start of the AU-4 mapping signal or the AU-3 mapping signal.

In order to discriminate the AU-4 mapping signal and the AU-3 mapping signal, the AU pointer has an AU-4 pointer structure or an AU-3 pointer structure which are different. The AU pointer exists within the H bytes, and the AU-3 pointer and the AU-4 pointer can be distinguished from the structure of the H bytes.

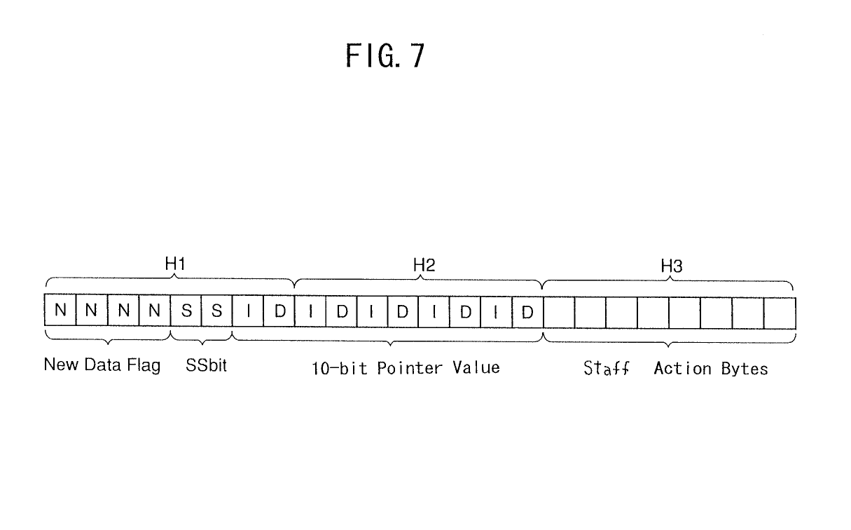

FIG. 7 is a diagram showing a structure of the H bytes. The H bytes are formed from a H1 byte, a H2 byte, and a H3 byte. The H3 byte is also referred to as a stuff action byte, and is not directly related to pointer processing and the AU-3 and AU-4 mapping signals. Sixteen bits of each of the H1 and H2 bytes have the following functions. The first four bits are called a new data flag (NDF), and indicates whether or not a change occurred in a pointer value with respect to a previous pointer value. The first four bits are “1001” if a change occurred with respect to the previous pointer value, and are “0110” if no change occurred with respect to the previous pointer value. The next two bits are called SS bites, and are “00” in the case of the SONET signal and are “10” in the case of the SDH signal. The remaining ten bits indicate the actual pointer value.

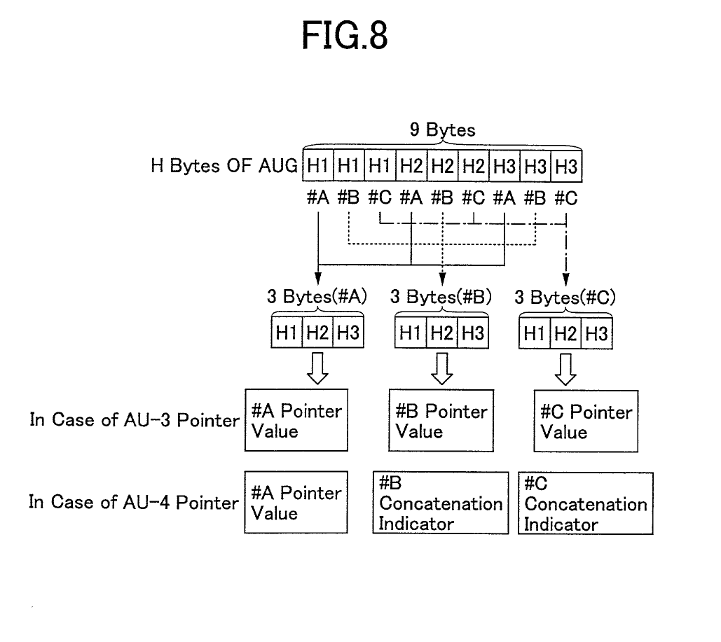

FIG. 8 is a diagram showing a structure of the H bytes of the AUG. The AUG obtained from the STM-N frame has the H bytes amounting to nine bytes as shown in FIG. 8. The nine bytes are divided into three groups #A, #B and #C, where each of the three groups #A, #B and #C is made up of the Hl byte, the H2 byte and the H3 byte and amount to three bytes. In a case where the H bytes include the AU-3 pointer, the H bytes of each of the groups #A, #B and #C have a valid pointer value. On the other hand, in a case where the H bytes include the AU-4 pointer, the H bytes of the group #A have a valid pointer value, and the H bytes of the groups #B and #C have a concatenation indicator with a fixed value.

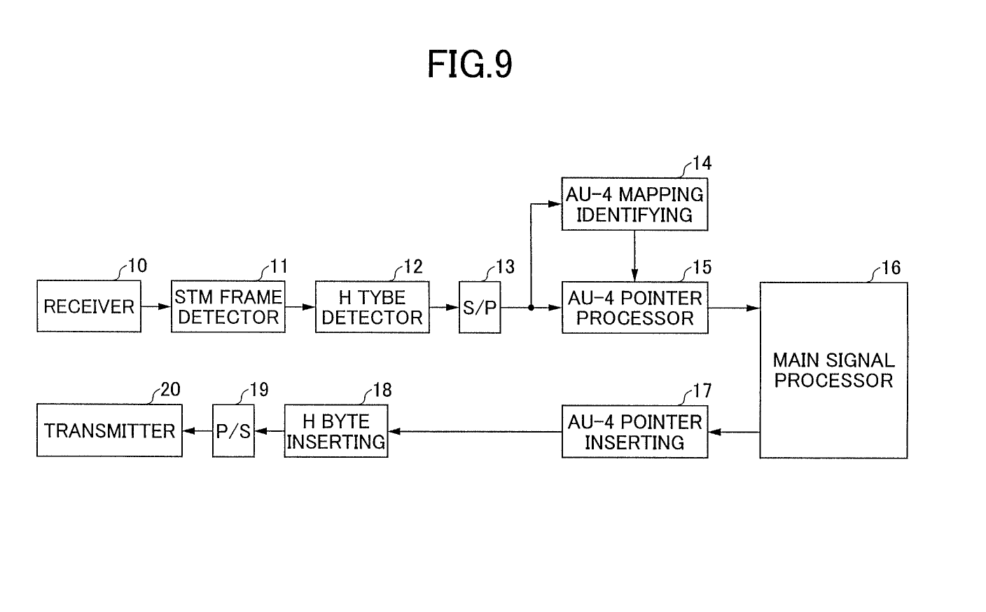

FIG. 9 is a system block diagram showing an important part of a conventional SDH apparatus which receives the AU-4 mapping signal. In FIG. 9, a receiver section 10 receives an optical signal, and a STM frame detector 11 extracts the STM frame (OC frame in the case of the SONET) of the SDH signal, and a H byte detector 12 extracts the H bytes. A serial-to-parallel (S/P) converter 13 carries out a S/P conversion with respect to the extracted H bytes, and supplies the parallel H bytes an AU-4 mapping identifying section 14 and an AU-4 pointer processor 15. The AU-4 mapping identifying section 14 identifies the AU-4 mapping signal when the received signal is the AU-4 mapping signal, and notifies the identified AU-4 mapping signal to the AU-4 pointer processor 15. The AU-4 pointer processor 15 extracts the AU-4 pointer in response to the notification of the AU-4 mapping signal, and supplies payload data obtained to a main signal processor 16.

When outputting the data from the main signal processor 16, an AU-4 pointer inserting section 17 inserts the AU-4 pointer to the H bytes of the group #A, and inserts the concatenation indicator having the fixed value to the H bytes of the groups #B and #C. A H byte inserting section 18 inserts the H bytes, including the NDF, the SS bits and the stuff action bytes, to the data supplied from the main signal processor 16 via the AU-4 pointer inserting section 17. Thereafter, a parallel-to-serial (P/S) converter 19 carries out a P/S conversion, and a transmitter section 20 transmits the AU-4 mapping signal.

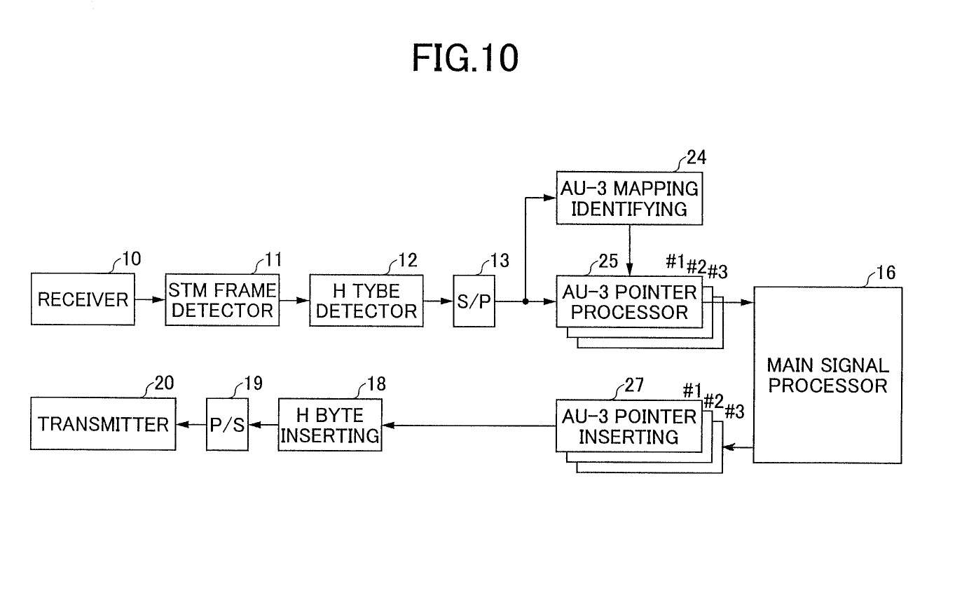

FIG. 10 is a system block diagram showing an important part of a SDH apparatus in a first embodiment of the present invention. In FIG. 10, those parts which are the same as those corresponding parts in FIG. 9 are designated by the same reference numerals.

In FIG. 10, the receiver section 10 receives the optical signal, the STM frame detector 11 detects the STM frame of the SDH signal, and the H byte detector 12 extracts the H bytes. The S/P converter 13 carries out the S/P conversion with respect to the extracted H bytes. The H bytes output from the S/P converter 13 are supplied to an AU-3 mapping identifying section 24 and three AU-3 pointer processors 25 (#1, #2, #3). The AU-3 mapping identifying section 24 identifies the AU-3 mapping signal when the received signal is the AU-3 mapping signal, and notifies the identified AU-3 mapping signal to the three AU-3 pointer processors 25 (#1, #2, #3). The AU-3 pointer processors 25 (#1, #2, #3) extract the AU-3 pointer from the H bytes of the corresponding groups #A, #B and #C, in response to the notification of the AU-3 mapping signal, and supplies payload data obtained to the main signal processor 16.

When outputting the data from the main signal processor 16, three AU-3 pointer inserting sections 27 (#1, #2, #3) insert the AU-3 pointer to the H bytes of the corresponding groups #A, #B and #C. The H byte inserting section 18 inserts the H bytes, including the NDF, the SS bits and the stuff action bytes, to the data supplied from the main signal processor 16 via the three AU-3 pointer inserting sections 27 (#1, #2, #3). Thereafter, the P/S converter 19 carries out the P/S conversion, and the transmitter section 20 transmits the AU-3 mapping signal.

Accordingly, even in the case of the SDH apparatus, it is possible to mutually connect the SDH apparatus and the SONET apparatus, if the AU-4 mapping identifying section 14, the AU-3 pointer processor 15 and the AU-4 pointer inserting section 17 shown in FIG. 9 are replaced by the AU-3 mapping identifying section 24, the three AU-3 pointer processors 25 (#1, #2, #3) and the three AU-3 pointer inserting sections 27 (#1, #2, #3) shown in FIG. 10.

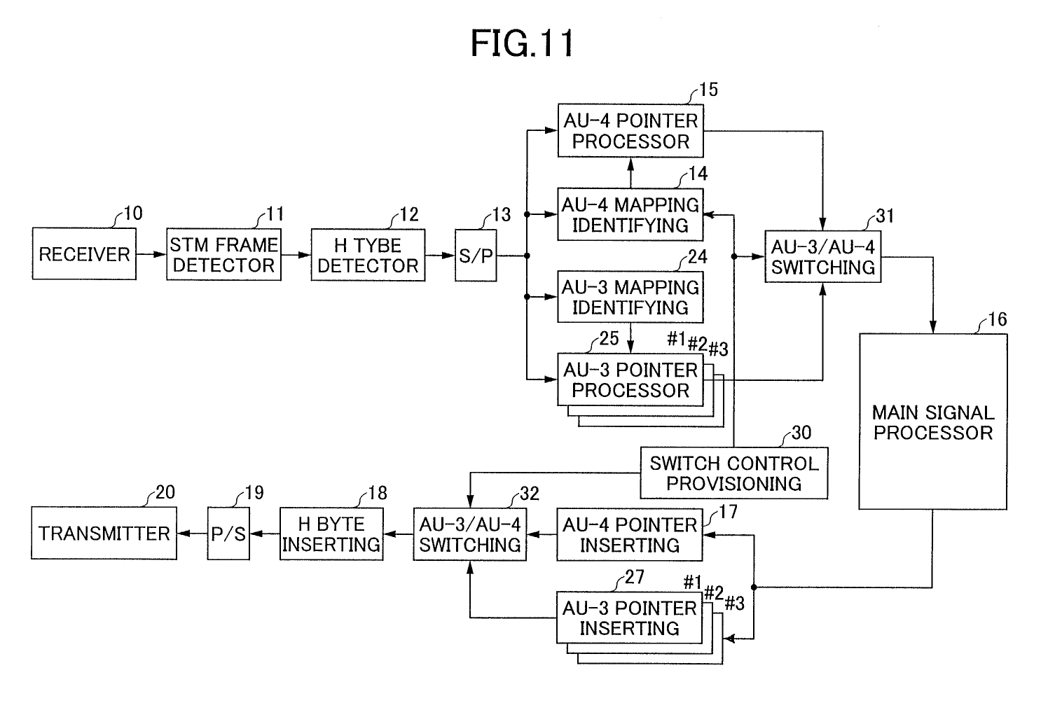

FIG. 11 is a system block diagram showing an important part of a SDH apparatus in a second embodiment of the present invention. In FIG. 11, those parts which are the same as those corresponding parts in FIGS. 9 and 10 are designated by the same reference numerals.

In FIG. 11, the receiver section 10 receives the optical signal, the STM frame detector 11 extracts the STM frame of the SDH signal, and the H byte detector 12 extracts the H bytes. The S/P converter 13 carries out the S/P conversion with respect to the extracted H bytes. The H bytes output from the S/P converter 13 are supplied to the AU-4 mapping identifying section 14, the AU-4 pointer processor 15, the AU-3 mapping identifying section 24 and the three AU-3 pointer processors 25 (#1, #2, #3).

A switch control provisioning section 30 supplies a control signal for selecting the AU-3 or the AU-4 according to a setting (provisioning) of a system manager, to the AU-4 mapping identifying section 14, the AU-3 mapping identifying section 24 and an AU-3/AU-4 switching sections 31 and 32.

The AU-4 mapping identifying section 14 identifies the AU-4 mapping signal when the received signal is the AU-4 mapping signal, if the control signal selecting the AU-4 is received from the switch control provisioning section 30, and notifies the identified AU-4 mapping signal to the AU-4 pointer processor 15. The AU-4 pointer processor 15 extracts the AU-4 pointer in response to the notification of the AU-4 mapping signal, and supplies the payload data obtained to the AU-3/AU-4 switching section 31.

The AU-3 mapping identifying section 24 identifies the AU-3 mapping signal when the received signal is the AU-3 mapping signal, if the control signal selecting the AU-3 is received from the switch control provisioning section 30, and notifies the identified AU-3 mapping signal to the three AU-3 pointer processors 25 (#1, #2, #3). The AU-3 pointer processors 25 (#1, #2, #3) extract the AU-3 pointer from the H bytes of the corresponding groups #A, #B and #C, in response to the notification of the AU-3 mapping signal, and supplies payload data obtained to the AU-3/AU-4 switching section 31.

The AU-3/AU-4 switching section 31 selectively supplies to the main signal processor 16 the payload data from the AU-4 pointer processor 15 or the three AU-3 pointer processors 25 (#1, #2, #3), depending on the control signal supplied from the switch control provisioning section 30.

When outputting the data from the main signal processor 16, the AU-4 pointer inserting section 17 inserts the AU-4 pointer to the H bytes of the group #A, and inserts the concatenation indicator having the fixed value to the H bytes of the groups #B and #C, before supplying the data to the AU-3/AU-3 switching section 32. On the other hand, the three AU-3 pointer inserting sections 27 (#1, #2, #3) insert the AU-3 pointer to the H bytes of the corresponding groups #A, #B and #C, before supplying the data to the AU-3/AU-3 switching section 32.

The AU-3/AU-4 switching section 32 selectively supplies to the H byte inserting section 18 the H bytes from the AU-4 pointer inserting section 17 or the three AU-3 pointer inserting sections 27 (#1, #2, #3), depending on the control signal supplied from the switch control provisioning section 30. The H byte inserting section 18 inserts the H bytes, including the NDF, the SS bits and the stuff action bytes, to the data supplied from the main signal processor 16 via the AU-4 pointer inserting section 17 and the AU-3/AU-4 switching section 32 or, via the three AU-3 pointer inserting sections 27 (#1, #2, #3) and the AU-3/AU-4 switching section 32. Thereafter, the P/S converter 19 carries out the P/S conversion, and the transmitter section 20 transmits the AU-4 mapping signal when the AU-4 is selected by the system manager, and transmits the AU-3 mapping signal when the AU-3 is selected by the system manager.

Therefore, this embodiment is provided with the three AU-3 pointer processors 25 (#1, #2, #3), the three AU-3 pointer inserting sections 27 (#1, #2, #3), the AU-4 pointer processor 15 and the AU-4 pointer inserting section 17, and the AU-3/AU-4 switching sections 31 and 32 are switched and controlled by the switch control provisioning section 30, so as to process the selected one of the AU-3 mapping signal and the AU-4 mapping signal. Hence, it is possible to selectively receive and transmit the AU-3 mapping signal and the AU-4 mapping signal depending on the setting (provisioning) made by the system manager.

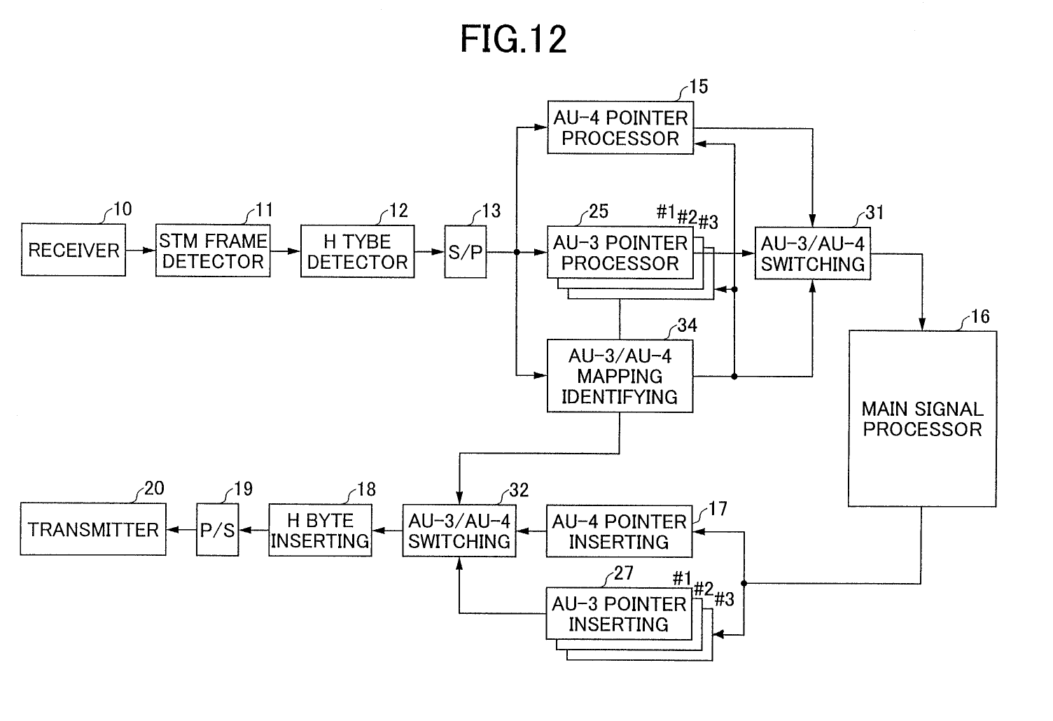

FIG. 12 is a system block diagram showing an important part of a SDH apparatus in a third embodiment of the present invention. In FIG. 12, those parts which are the same as those corresponding parts in FIG. 11 are designated by the same reference numerals.

In FIG. 12, the receiver section 10 receives the optical signal, the STM frame detector 11 extracts the STM frame of the SDH signal, and the H byte detector 12 extracts the H bytes. The S/P converter 13 carries out the S/P conversion with respect to the extracted H bytes. The H bytes output from the S/P converter 13 are supplied to the AU-4 pointer processor 15, the three AU-3 pointer processors 25 (#1, #2, #3) and an AU-3/AU-4 mapping identifying section 34.

The AU-3/AU-4 mapping identifying section 34 separates the H bytes included in the received signal into the groups #A, #B and #C, and identifies the AU-3 mapping signal or the AU-4 mapping signal depending on whether the pointer values of the groups #A, #B and #C indicate the concatenation indicator having the fixed value. The AU-3/AU-4 mapping identifying section 34 generates a control signal for selecting the AU-3 or the AU-4, depending on whether the AU-3 mapping signal or the AU-4 mapping signal is identified, and supplies this control signal to the AU-3/AU-4 switching sections 31 and 32.

The AU-4 pointer processor 15 extracts the AU-4 pointer from the H bytes of the group #A of the received signal if the notification from the AU-3/AU-4 mapping identifying section 34 identifies the AU-4 mapping signal, and supplies the payload data obtained to the AU-3/AU-4 switching section 31. The AU-3 pointer processors 25 (#1, #2, #3) extract the AU-3 pointer from the H bytes of the corresponding groups #A, #B and #C, in response to the notification from the AU-3/AU-4 mapping identifying section 34 identifies the AU-3 mapping signal, and supplies payload data obtained to the AU-3/AU-4 switching section 31.

The AU-3/AU-4 switching section 31 selectively supplies to the main signal processor 16 the payload data from the AU-4 pointer processor 15 or the three AU-3 pointer processors 25 (#1, #2, #3), depending on the control signal supplied from the AU-3/AU-4 mapping identifying section 34.

When outputting the data from the main signal processor 16, the AU-4 pointer inserting section 17 inserts the AU-4 pointer to the H bytes of the group #A, and inserts the concatenation indicator having the fixed value to the H bytes of the groups #B and #C, before supplying the data to the AU-3/AU-3 switching section 32. On the other hand, the three AU-3 pointer inserting sections 27 (#1, #2, #3) insert the AU-3 pointer to the H bytes of the corresponding groups #A, #B and #C, before supplying the data to the AU-3/AU-3 switching section 32.

The AU-3/AU-4 switching section 32 selectively supplies to the H byte inserting section 18 the H bytes from the AU-4 pointer inserting section 17 or the three AU-3 pointer inserting sections 27 (#1, #2, #3), depending on the control signal supplied from the AU-3/AU-4 mapping identifying section 34. The H byte inserting section 18 inserts the H bytes, including the NDF, the SS bits and the stuff action bytes, to the data supplied from the main signal processor 16 via the AU-4 pointer inserting section 17 and the AU-3/AU-4 switching section 32 or, via the three AU-3 pointer inserting sections 27 (#1, #2, #3) and the AU-3/AU-4 switching section 32. Thereafter, the P/S converter 19 carries out the P/S conversion, and the transmitter section 20 transmits the AU-4 mapping signal or the AU-3 mapping signal.

In this embodiment, the AU-3/AU-4 mapping identifying section 34 identifies the AU-3 mapping signal and the AU-4 mapping signal, and also controls the AU-3/AU-4 switching sections 31 and 32 depending on the identified AU-3 or AU-4 mapping signal. For this reason, it is possible to simplify the circuit structure, and to automatically switch and control the AU-3/AU-4 switching sections 31 and 32

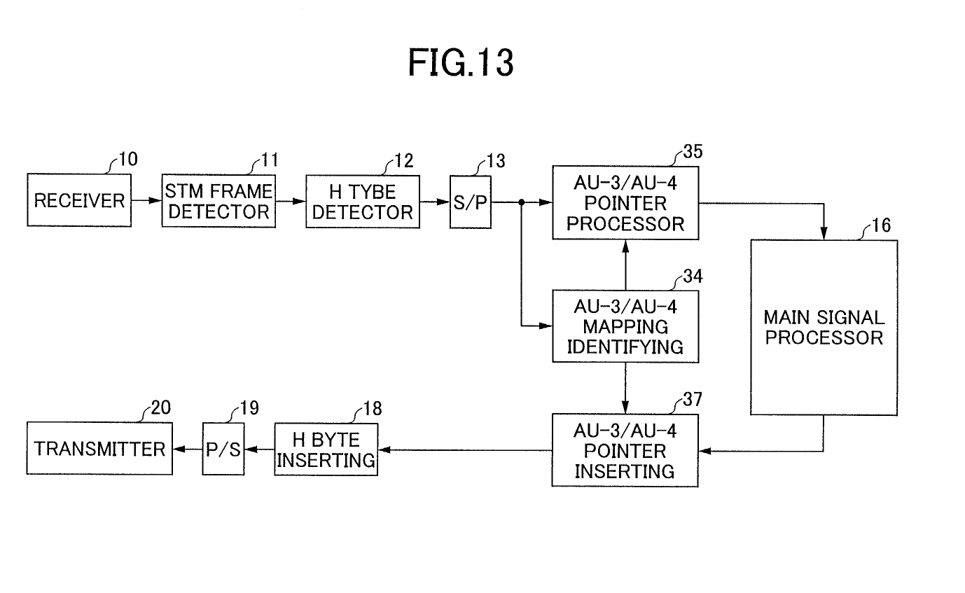

FIG. 13 is a system block diagram showing an important part of a SDH apparatus in a fourth embodiment of the present invention. In FIG. 13, those parts which are the same as those corresponding parts in FIG. 11 are designated by the same reference numerals, and a description thereof will be omitted.

In FIG. 13, the receiver section 10 receives the optical signal, the STM frame detector 11 extracts the STM frame of the SDH signal, and the H byte detector 12 extracts the H bytes. The S/P converter 13 carries out the S/P conversion with respect to the extracted H bytes. The H bytes output from the S/P converter 13 are supplied to an AU-3/AU-4 pointer processor 35 and the AU-3/AU-4 mapping identifying section 34.

The AU-3/AU-4 mapping identifying section 34 separates the H bytes included in the received signal into the groups #A, #B and #C, and identifies the AU-3 mapping signal or the AU-4 mapping signal depending on whether the pointer values of the groups #A, #B and #C indicate the concatenation indicator having the fixed value. The AU-3/AU-4 mapping identifying section 34 supplies the identified result, that is, whether the AU-3 mapping signal or the AU-4 mapping signal is identified, to the AU-3/AU-4 pointer processor 35 and an AU-3/AU-4 pointer inserting section 37.

The AU-3/AU-4 pointer processor 35 extracts the AU-4 pointer from the H bytes of the group #A of the received signal when the received signal is the AU-4 mapping signal, and supplies the payload data obtained to the main signal processor 16. On the other hand, the AU-3/AU-4 pointer processor 35 extracts the AU-3 pointer from the H bytes of the corresponding groups #A, #B and #C when the received signal is the AU-3 mapping signal, and supplies payload data obtained to the main signal processor 16.

When outputting the data from the main signal processor 16, the AU-3/AU-4 pointer inserting section 37 inserts the AU-4 pointer to the H bytes of the group #A, and inserts the concatenation indicator having the fixed value to the H bytes of the groups #B and #C. On the other hand, the three AU-3/AU-4 pointer inserting section 37 inserts the AU-3 pointer to the H bytes of the groups #A, #B and #C. The AU-3/AU-4 pointer inserting section 37 selectively supplies the data (H bytes) inserted with the AU-3 pointer or the AU-4 pointer to the H byte inserting section 18, depending on the control signal which is received from the AU-3/AU-4 mapping identifying section 34 and indicates whether the AU-3 mapping signal or the AU-4 mapping signal is identified as the received signal.

The H byte inserting section 18 inserts the H bytes, including the NDF, the SS bits and the stuff action bytes, to the data supplied from the main signal processor 16 via the AU-4 pointer inserting section 17 and the AU-3/AU-4 pointer inserting section 37. Thereafter, the P/S converter 19 carries out the P/S conversion, and the transmitter section 20 transmits the AU-4 mapping signal or the AU-3 mapping signal.

According to this embodiment, the AU-3/AU-4 pointer processor 35 includes the functions of the AU-3 pointer processor 25 and the AU-4 pointer processor 14 shown in FIG. 12. In addition, the AU-3/AU-4 pointer inserting section 37 includes the functions of the AU-3 pointer inserting sections 27 and the AU-4 pointer inserting section 17 shown in FIG. 12. As a result, it is possible to further simplify the circuit structure compared to the second embodiment described above.

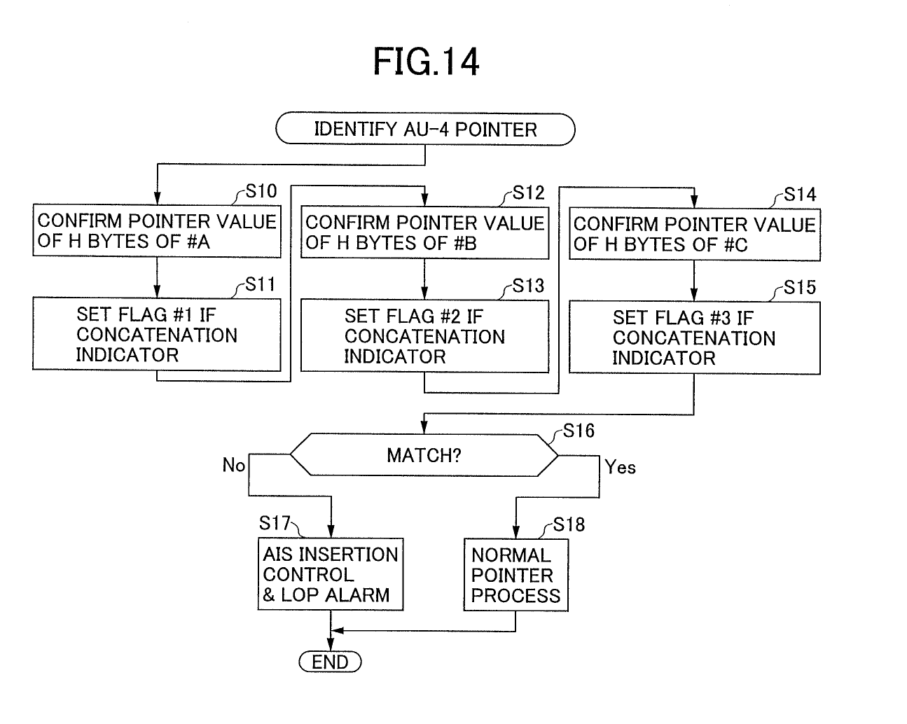

FIG. 14 is a flow chart for explaining an embodiment of a process carried out by the AU-4 mapping identifying section 14. Before this process is carried out, flags #1, #2 and #3 are cleared to “0”. In FIG. 14, a step S10 confirms the pointer value of the H bytes of the group #A separated from the received signal, and a step S11 sets the flag #1 to “1” if the pointer value indicates the concatenation indicator having the fixed value. Next, a step S12 confirms the pointer value of the H bytes of the group #B separated from the received signal, and a step S13 sets the flag #2 to “1” if the pointer value indicates the concatenation indicator having the fixed value. Then, a step S14 confirms the pointer value of the H bytes of the group #C separated from the received signal, and a step S15 sets the flag #3 to “1” if the pointer value indicates the concatenation indicator having the fixed value.

A step S16 decides whether or not the values of the flags #1, #2 and #3 matches anticipated values “011”, that is, whether or not the flag #1=0, the flag #2=1 and the flag #3=1. If the decision result in the step S16 is NO, a step S17 generates a signal for declaring loss of pointer (LOP), and the AU-4 mapping processor 15 is controlled so as to notify the optical transmission apparatus located on the downstream side accordingly by inserting the AIS signal to the payload. On the other hand, if the decision result in the step S16 is NO, a step S18 controls the AU-4 mapping processor 15 so as to carry out a normal mapping process. The process ends after the step S17 or S18.

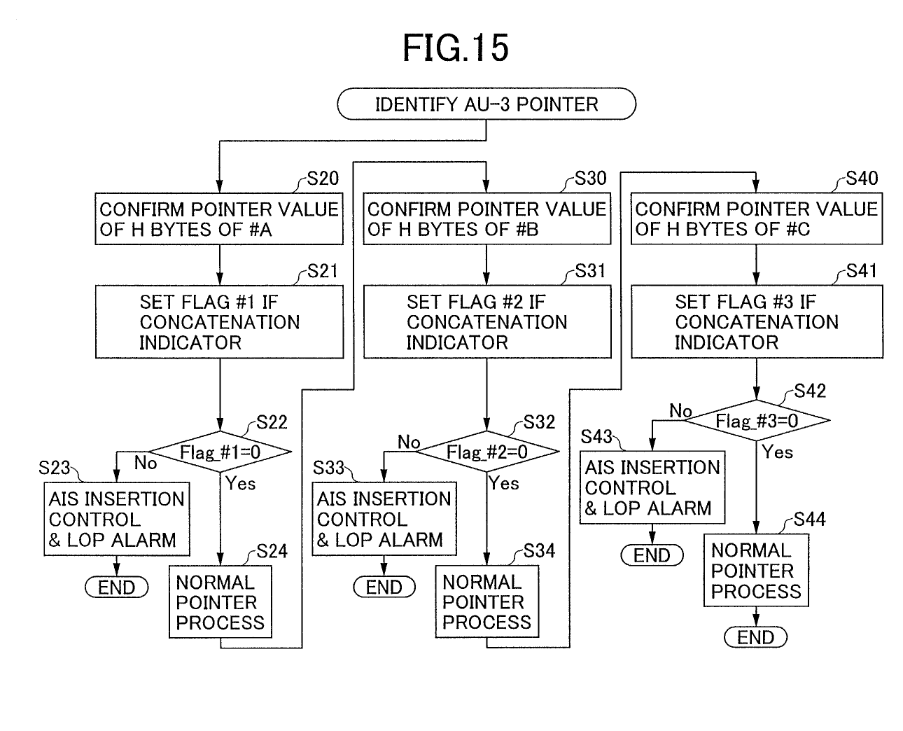

FIG. 15 is a flow chart for explaining an embodiment of a process carried out by the AU-3 mapping identifying section 24. Before this process is carried out, flags #1, #2 and #3 are cleared to “0”. In FIG. 15, a step S20 confirms the pointer value of the H bytes of the group #A separated from the received signal, and a step S21 sets the flag #1 to “1” if the pointer value indicates the concatenation indicator having the fixed value. A step S22 decides whether or not the value of the flag #1 is “0”. If the decision result in the step S22 is NO, a step S23 generates a signal for declaring LOP, and the AU-3 mapping processor 25 (#1) is controlled so as to notify the optical transmission apparatus located on the downstream side accordingly by inserting the AIS signal to the payload. The process ends after the step S23. On the other hand, if the decision result in the step S22 is YES, a step S24 controls the AU-3 mapping processor 25 (#1) so as to carry out a normal mapping process.

After the step S24, a step S30 confirms the pointer value of the H bytes of the group #B separated from the received signal, and a step S31 sets the flag #2 to “1” if the pointer value indicates the concatenation indicator having the fixed value. A step S32 decides whether or not the value of the flag #2 is “0”. If the decision result in the step S32 is NO, a step S33 generates a signal for declaring LOP, and the AU-3 mapping processor 25 (#2) is controlled so as to notify the optical transmission apparatus located on the downstream side accordingly by inserting the AIS signal to the payload. The process ends after the step S33. On the other hand, if the decision result in the step S32 is YES, a step S34 controls the AU-3 mapping processor 25 (#2) so as to carry out a normal mapping process.

After the step S34, a step S40 confirms the pointer value of the H bytes of the group #C separated from the received signal, and a step S41 sets the flag #3 to “1” if the pointer value indicates the concatenation indicator having the fixed value. A step S42 decides whether or not the value of the flag #3 is “0”. If the decision result in the step S42 is NO, a step S43 generates a signal for declaring LOP, and the AU-3 mapping processor 25 (#4) is controlled so as to notify the optical transmission apparatus located on the downstream side accordingly by inserting the AIS signal to the payload. The process ends after the step S43. On the other hand, if the decision result in the step S42 is YES, a step S44 controls the AU-2 mapping processor 25 (#3) so as to carry out a normal mapping process, and the process ends.

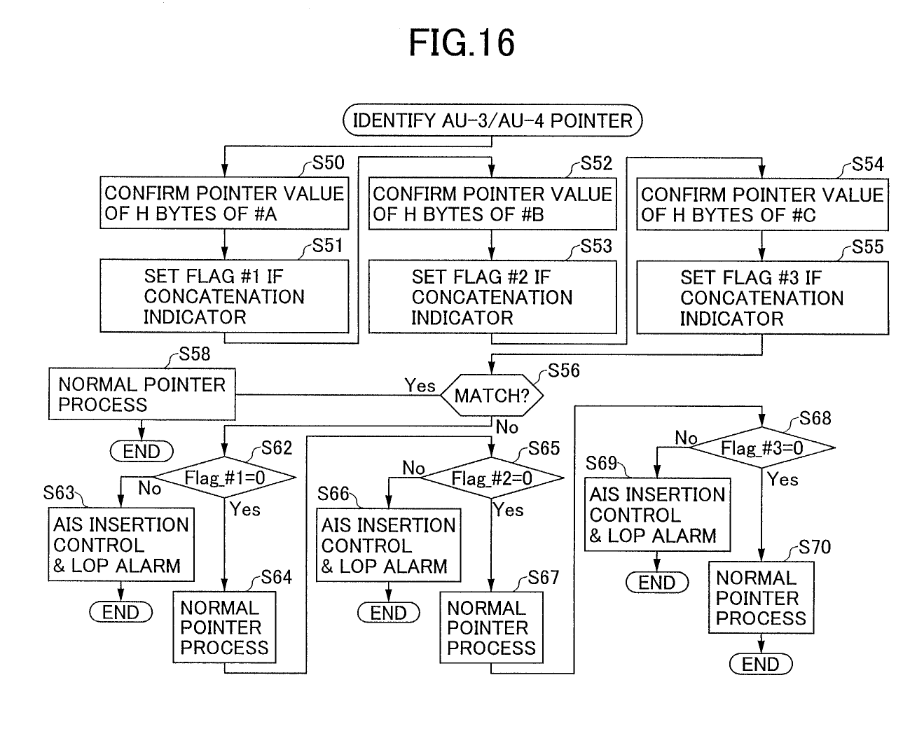

FIG. 16 is a flow chart for explaining an embodiment of a process carried out by the AU-3/AU-4 mapping identifying section 34. Before this process is carried out, flags #1, #2 and #3 are cleared to “0”. In FIG. 16, a step S50 confirms the pointer value of the H bytes of the group #A separated from the received signal, and a step S51 sets the flag #1 to “1” if the pointer value indicates the concatenation indicator having the fixed value. Next, a step S52 confirms the pointer value of the H bytes of the group #B separated from the received signal, and a step S53 sets the flag #2 to “1” if the pointer value indicates the concatenation indicator having the fixed value. Then, a step S54 confirms the pointer value of the H bytes of the group #C separated from the received signal, and a step S55 sets the flag #3 to “1” if the pointer value indicates the concatenation indicator having the fixed value.

A step S56 decides whether or not the values of the flags #1, #2 and #3 matches anticipated values “011”. If the decision result in the step S56 is YES, a step S58 controls the AU-4 mapping processor 15 so as to carry out a normal mapping process, and the process ends. On the other hand, the process advances to a step S62 if the decision result in the step S56 is NO.

The step S62 decides whether or not the value of the flag #1 is “0”. If the decision result in the step S62 is NO, a step S63 generates a signal for declaring LOP, and the AU-3 mapping processor 25 (#1) is controlled so as to notify the optical transmission apparatus located on the downstream side accordingly by inserting the AIS signal to the payload. The process ends after the step S63. On the other hand, if the decision result in the step S62 is YES, a step S64 controls the AU-3 mapping processor 25 (#1) so as to carry out a normal mapping process.

After the step S64, a step S65 decides whether or not the value of the flag #2 is “0”. If the decision result in the step S65 is NO, a step S66 generates a signal for declaring LOP, and the AU-3 mapping processor 25 (#2) is controlled so as to notify the optical transmission apparatus located on the downstream side accordingly by inserting the AIS signal to the payload. The process ends after the step S66. On the other hand, if the decision result in the step S65 is YES, a step S67 controls the AU-3 mapping processor 25 (#2) so as to carry out a normal mapping process.

After the step S67, a step S68 decides whether or not the value of the flag #3 is “0”. If the decision result in the step S68 is NO, a step S69 generates a signal for declaring LOP, and the AU-3 mapping processor 25 (#3) is controlled so as to notify the optical transmission apparatus located on the downstream side accordingly by inserting the AIS signal to the payload. The process ends after the step S69. On the other hand, if the decision result in the step S68 is YES, a step S70 controls the AU-3 mapping processor 25 (#3) so as to carry out a normal mapping process, and the process ends.

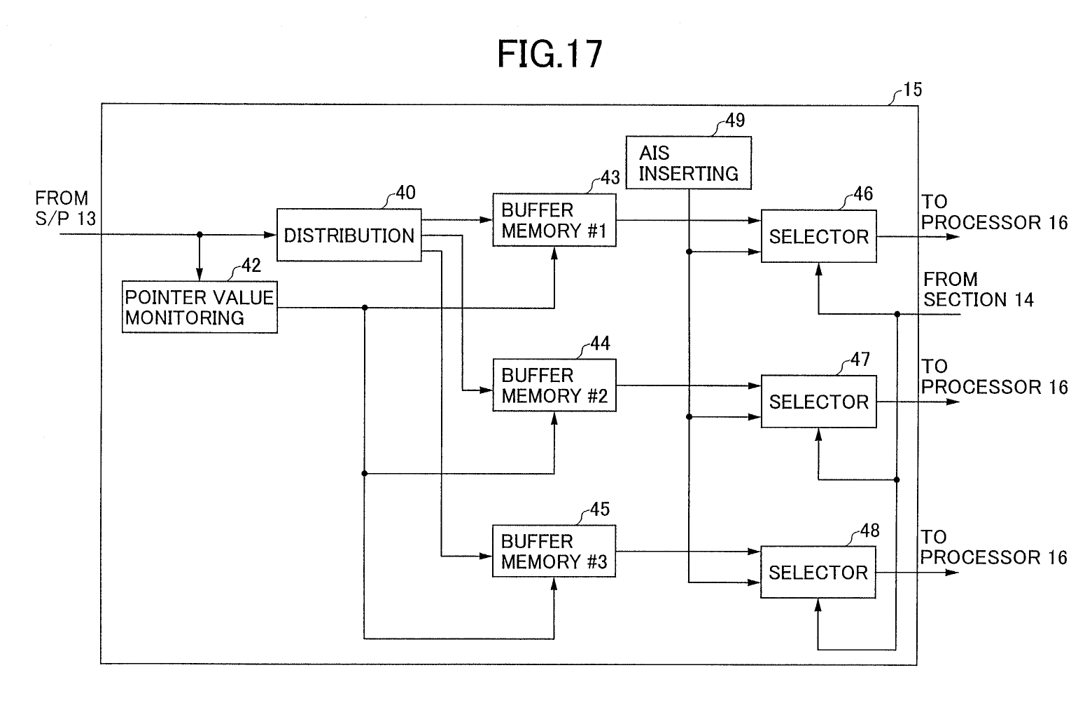

FIG. 17 is a system block diagram showing an embodiment of the AU-4 pointer processor 15. In FIG. 17, the data received from the S/P converter 13 is supplied to a distribution circuit 40 and a pointer value monitoring unit 42. The distribution circuit 40 successively distributes the received data to buffer memories 43, 44 and 45 in units of one byte. The pointer value monitoring unit 42 extracts the AU-4 pointer value from the received data, and supplies the AU-4 pointer value to each of the buffer memories 43, 44 and 45.

Each of the buffer memories 43, 44 and 45 finds the start of the data (payload) based on the AU-4 pointer value, and successively supplies the buffered data to a corresponding one of selectors 46, 47 and 48. An AIS signal from an AIS inserting section 49 is supplied to each of the selectors 46, 47 and 48. Hence, the selectors 46, 47 and 48 selectively output the data from the corresponding buffer memories 43, 44 and 45 if a notification (control) is made from the AU-4 mapping identifying section 14 or the like that the received signal is the AU-4 mapping signal, and otherwise selectively outputs the AIS signal received from the AIS inserting section 49.

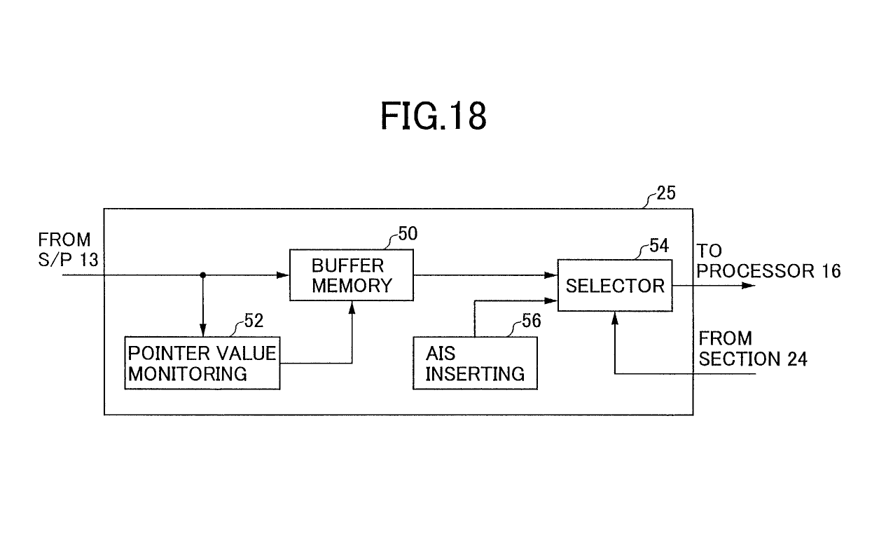

FIG. 18 is a system block diagram showing an embodiment of the AU-3 pointer processor 25. It is assumed for the sake of convenience that the AU-3 pointer processor 25 shown in FIG. 18 is the AU-3 pointer processor 25 (#1), but the AU-3 pointer processors 25 (#2, #3) have the same structure as the AU-3 pointer processor 25 (#1). In FIG. 18, the data received from the S/P converter 13 is supplied to a buffer memory 50 and a pointer value monitoring unit 52. The pointer value monitoring unit 52 extracts the AU-3 pointer value (group #A) from the received data, and supplies the AU-3 pointer value to the buffer memory 50.

The buffer memory 50 finds the start of the data (payload) based on the AU-3 pointer value, and successively supplies the buffered data to a selector 54. An AIS signal from an AIS inserting section 56 is supplied to the selector 54. Hence, the selector 54 selectively outputs the data from the buffer memory 50 if a notification (control) is made from the AU-3 mapping identifying section 24 that the received signal is the AU-3 mapping signal, and otherwise selectively output the AIS signal received from the AIS inserting section 56.

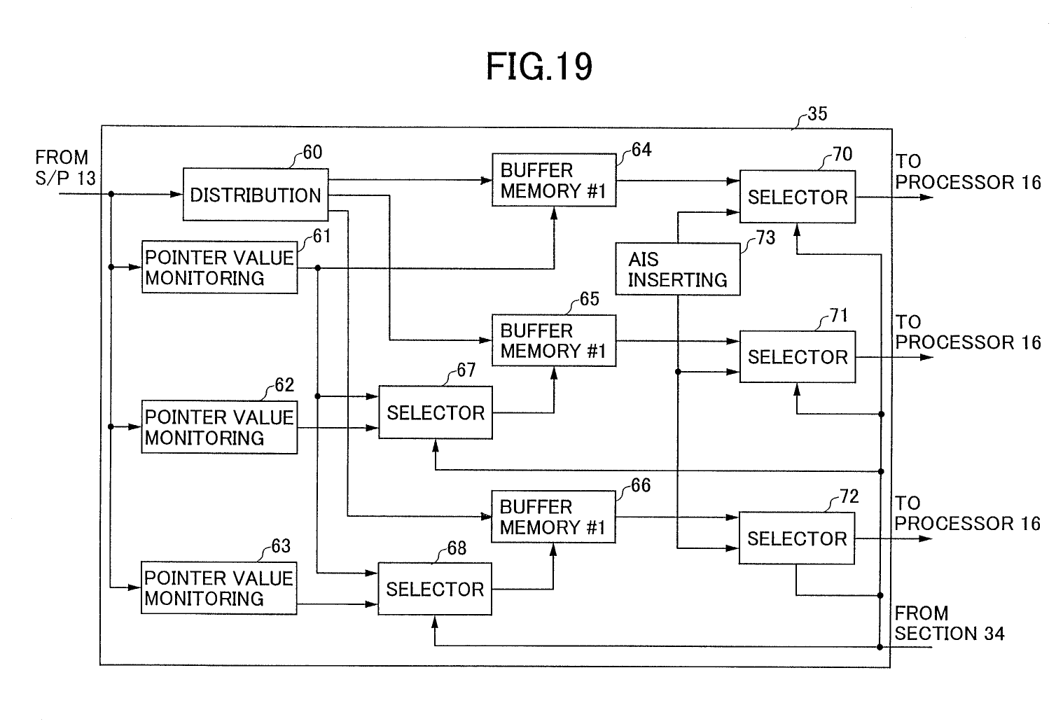

FIG. 19 is a system block diagram showing an embodiment of the AU-3/AU-4 pointer processor 35. In FIG. 19, the data received from the S/P converter 13 is supplied to a distribution circuit 60 and pointer value monitoring units 61, 62 and 63. The distribution circuit 60 successively distributes the received data to buffer memories 64, 65 and 66 in units of one byte. The pointer value monitoring unit 61 extracts the AU-3 pointer value or the AU-4 pointer value from the group #A of the received data, and supplies the AU-3 pointer value or the AU-4 pointer value to the buffer memory 64 and selectors 67 and 68. The pointer value monitoring unit 62 extracts the AU-3 pointer value or the AU-4 pointer value from the group #B of the received data, and supplies the AU-3 pointer value or the AU-4 pointer value to the selector 67. The pointer value monitoring unit 63 extracts the AU-3 pointer value or the AU-4 pointer value from the group #C of the received data, and supplies the AU-3 pointer value or the AU-4 pointer value to the selector 68. The selectors 67 and 68 selectively output the pointer value from the pointer value monitoring unit 61 if the notification (control) from the AU-3/AU-4 mapping identifying section 34 indicates that the received signal is the AU-4 mapping signal, and the selectively output pointer value is supplied to the corresponding buffer memories 65 and 66. On the other hand, the selectors 67 and 68 selectively output the pointer values from the corresponding pointer value monitoring units 62 and 53 if the notification (control) from the AU-3/AU-4 mapping identifying section 34 indicates that the received signal is the AU-3 mapping signal, and the selectively output pointer values are supplied to the corresponding buffer memories 65 and 66.

Each of the buffer memories 64, 65 and 66 finds the start of the data (payload) based on the received pointer value, and successively supplies the buffered data to a corresponding one of selectors 70, 71 and 72. An AIS signal from an AIS inserting section 73 is supplied to each of the selectors 70, 71 and 72. Hence, the selectors 70, 71 and 72 selectively output the data from the corresponding buffer memories 64, 65 and 66 if a notification (control) is made from the AY-3/AU-4 mapping identifying section 34 that the received signal is the AU-4 mapping signal, and otherwise selectively output the AIS signal received from the AIS inserting section 73.

The H byte detector 12 forms a H byte detecting means, and the AU-3 mapping identifying section 24 forms an AU-3 mapping judging means. The AU-3 pointer processor 25 forms an AU-3 pointer processing means, and the AU-4 pointer processor 15 forms an AU-4 pointer processing means. The switch control provisioning section 30 forms a provisioning means, the AU-3 pointer inserting section 27 forms an AU-3 pointer inserting means, and the AU-4 pointer inserting section 17 forms an AU-4 pointer inserting means. The AU-3/AU-4 mapping identifying section 34 forms a mapping judging means, and the AU-3/AU-4 pointer processor 35 forms an AU-3/AU-4 pointer processing means. The pointer value monitoring units 61, 62 and 63 form a pointer value extracting means, and the selectors 67 and 68 form a pointer value selecting means. The buffer memories 64, 65 and 66 form an output means.

Further, the present invention is not limited to these embodiments, but various variations and modifications may be made without departing from the scope of the present invention.

What is claimed is:

1. A synchronous digital multiplex transmission method comprising the steps of:
(a) detecting H bytes from an administrative unit group (AUG) forming a synchronous transport module (STM) of a received signal;
(b) judging whether the received signal is an AU-3 mapping signal of a synchronous optical network (SONET) or an administrative unit (AU)-4 mapping signal of a synchronous digital hierarchy (SDH) system, based on values of H1 bytes, H2 bytes and H3 bytes which form the H bytes;
(c) carrying out an administrative unit (AU)-3 pointer process which uses the H1 bytes, the H2 bytes, the H3 bytes and pointer values thereof, with respect to the received signal, when the received signal is judged as the AU-3 mapping signal by said step (b);
(d) carrying out an AU-4 pointer process which uses a pointer value of the H1 bytes, with respect to the received signal, when the received signal is judged as the AU-4 mapping signal by said step (b);
(e) inserting a pointer value in each of the H1 bytes, the H2 bytes and the H3 bytes, with respect to a transmitting signal, when the received signal is judged as the AU-3 mapping signal by said step (b); and
(f) inserting a pointer value in the H1 bytes, with respect to the transmitting signal, when the received signal is judged as the AU-4 mapping signal by said step (b).

2. A synchronous digital multiplex transmission apparatus comprising:
H byte detecting means for detecting H bytes from an administrative unit group (AUG) forming a synchronous transport module (STM) of a received signal;
AU-3 mapping judging means for judging whether the received signal is an AU-3 mapping signal of a synchronous optical network (SONET), based on values of H1 bytes, H2 bytes and H3 bytes which form the H bytes;
AU-3 pointer processing means for carrying out an administrative unit (AU)-3 pointer process which uses the H1 bytes, the H2 bytes, the H3 bytes and pointer values thereof, with respect to the received signal, when the received signal is judged as the AU-3 mapping signal by said AU-3 mapping judging means; and
AU-3 pointer inserting means for carrying out an AU-3 pointer insertion by inserting a pointer value in each of the H1 bytes, the H2 bytes and the H3 bytes, with respect to a transmitting signal, when the received signal is judged as the AU-3 mapping signal by said AU-3 mapping judging means.

3. A synchronous digital multiplex transmission apparatus comprising:
H byte detecting means for detecting H bytes from an administrative unit group (AUG) forming a synchronous transport module (STM) of a received signal;
provisioning means for instructing an administrative unit (AU)-3 pointer process of a synchronous optical network (SONET) or an administrative unit (AU)-4 pointer process of a synchronous digital hierarchy (SDH) system;
AU-3 pointer processing means for carrying out the AU-3 pointer process which uses the H1 bytes, the H2 bytes, the H3 bytes and pointer values thereof, with respect to the received signal, when the AU-3 pointer process is instructed from said provisioning means;
AU-4 pointer processing means for carrying out the AU-4 pointer process which uses a pointer value of the H1 bytes, with respect to the received signal, when the AU-4 pointer process is instructed from said provisioning means;
AU-3 pointer inserting means for carrying out an AU-3 pointer insertion by inserting a pointer value in each of the H1 bytes, the H2 bytes and the H3 bytes, with respect to a transmitting signal, when the AU-3 pointer process is instructed from said provisioning means; and
AU-4 pointer inserting means for carrying out an AU-4 pointer insertion by inserting a pointer value in the H1 bytes, with respect to the transmitting signal, when the AU-4 pointer process is instructed from said provisioning means.

4. A synchronous digital multiplex transmission apparatus comprising:
H byte detecting means for detecting H bytes from an administrative unit group (AUG) forming a synchronous transport module (STM) of a received signal;
mapping judging means for judging whether the received signal is an AU-3 mapping signal of a synchronous optical network (SONET) or an administrative unit (AU)-4 mapping signal of a synchronous digital hierarchy (SDH) system, based on values of H1 bytes, H2 bytes and H3 bytes which form the H bytes;
AU-3 pointer processing means for carrying out an administrative unit (AU)-3 pointer process which uses the H1 bytes, the H2 bytes, the H3 bytes and pointer values thereof, with respect to the received signal, when the received signal is judged as the AU-3 mapping signal by said mapping judging means;
AU-4 pointer processing means carrying out an AU-4 pointer process which uses a pointer value of the H1 bytes, with respect to the received signal, when the received signal is judged as the AU-4 mapping signal by said mapping judging means;
AU-3 pointer inserting means for carrying out an AU-3 pointer insertion by inserting a pointer value in each of the H1 bytes, the H2 bytes and the H3 bytes, with respect to a transmitting signal, when the received signal is judged as the AU-3 mapping signal by said mapping judging means; and
AU-4 pointer inserting means for carrying out an AU-4 pointer insertion by inserting a pointer value in the H1 bytes, with respect to the transmitting signal, when the received signal is judged as the AU-4 mapping signal by said mapping judging means.

5. The synchronous digital multiplex transmission apparatus as claimed in claim 4, comprising:
AU-3/AU-4 pointer processing means, integrally including said AU-3 pointer processing means and said AU-4 pointer processing means, for carrying out the AU-3 pointer process with respect to the received signal, when the received signal is the AU-3 mapping signal, and for carrying out the AU-4 pointer process with respect to the received signal, when the received signal is the AU-4 mapping signal.

6. The synchronous digital multiplex transmission apparatus as claimed in claim 4, wherein said mapping judging means judges that the received signal is the AU-4 mapping signal of the SDH system if the H1 bytes do not have a predetermined fixed value and each of the H2 and H3 bytes have the predetermined fixed value, and judges that the received signal is the AU-3 mapping signal of the SONET system if each of the H1, H2 and H3 bytes does not have the predetermined fixed value.

7. The synchronous digital multiplex transmission apparatus as claimed in claim 5, wherein said AU-3/AU-4 pointer processing means comprises:
pointer value extracting means for extracting the pointer values of each of the H1, H2 and H3 bytes;
pointer value selecting means for selecting the extracted pointer values of each of the H1, H2 and H3 bytes in the case of the AU-3 mapping signal, and selecting the extracted pointer value of the H1 bytes in the case of the AU-4 mapping signal; and
output means for buffering and outputting data from the received signal, based on the pointer values or pointer value selected by said pointer value selecting means.

8. The synchronous digital multiplex transmission apparatus as claimed in claim 7, wherein said output means includes three circuit sections for independently buffering and outputting the data from the received signal responsive to the corresponding extracted pointer values of the H1, H2 and H3 bytes.

9. A synchronous digital multiplex transmission apparatus comprising:
a H byte detector which detects H bytes from an administrative unit group (AUG) forming a synchronous transport module (STM) of a received signal;
a provisioning section which instructs an administrative unit (AU)-3 pointer process of a synchronous optical network (SONET) or an administrative unit (AU)-4 pointer process of a synchronous digital hierarchy (SDH) system;
an AU-3 pointer processor which carries out the AU-3 pointer process using the H1 bytes, the H2 bytes, the H3 bytes and pointer values thereof, with respect to the received signal, when the AU-3 pointer process is instructed from said provisioning section;
an AU-4 pointer processor which carries out the AU-4 pointer process using a pointer value of the H1 bytes, with respect to the received signal, when the AU-4 pointer process is instructed from said provisioning section;
an AU-3 pointer inserting section which carries out an AU-3 pointer insertion by inserting a pointer value in each of the H1 bytes, the H2 bytes and the H3 bytes, with respect to a transmitting signal, when the AU-3 pointer process is instructed from said provisioning section; and
an AU-4 pointer inserting section which carries out an AU-4 pointer insertion by inserting a pointer value in the H1 bytes, with respect to the transmitting signal, when the AU-4 pointer process is instructed from said provisioning section.

10. A synchronous digital multiplex transmission apparatus comprising:
a H byte detector which detects H bytes from an administrative unit group (AUG) forming a synchronous transport module (STM) of a received signal;
a mapping identifying section which judges whether the received signal is an AU-3 mapping signal of a synchronous optical network (SONET) or an administrative unit (AU)-4 mapping signal of a synchronous digital hierarchy (SDH) system, based on values of H1 bytes, H2 bytes and H3 bytes which form the H bytes;
an AU-3 pointer processor which carries out an administrative unit (AU)-3 pointer process using the H1 bytes, the H2 bytes, the H3 bytes and pointer values thereof, with respect to the received signal, when the received signal is judged as the AU-3 mapping signal by said mapping identifying section;
an AU-4 pointer processor which carries out an AU-4 pointer process using a pointer value of the H1 bytes, with respect to the received signal, when the received signal is judged as the AU-4 mapping signal by said mapping identifying section;
an AU-3 pointer inserting section which carries out an AU-3 pointer insertion by inserting a pointer value in each of the H1 bytes, the H2 bytes and the H3 bytes, with respect to a transmitting signal, when the received signal is judged as the AU-3 mapping signal by said mapping identifying section; and
an AU-4 pointer inserting section which carries out an AU-4 pointer insertion by inserting a pointer value in the H1 bytes, with respect to the transmitting signal, when the received signal is judged as the AU-4 mapping signal by said mapping identifying section.
